(19) United States
(12) Patent Application Publication
(10) Pub. No.: US 2025/0252622 A1
(43) Pub. Date: Aug. 7, 2025

(54) PHASE-RESTORING TRANSLATIONAL SHIFTING OF MULTIDIMENSIONAL IMAGES

(71) Applicant: Nanyang Technological University, Singapore (SG)

(72) Inventors: Tong LING, Singapore (SG); Huakun LI, Singapore (SG)

(21) Appl. No.: 18/856,915

(22) PCT Filed: Apr. 25, 2023
(86) PCT No.: PCT/SG2023/050286

§ 371 Date: Oct. 15, 2024

(30) Foreign Application Priority Data
Apr. 25, 2022 (SG) 10202204323S

(51) Int. Cl. G06T 11/00

(52) U.S. Cl. CPC G06T 11/006; G06T 2210/22; G06T 2211/456

(57) ABSTRACT

Disclosed is a method for phase-restoring translational shifting of a multidimensional image. The method comprises computing a first shifted, complex-valued image by converting a spectral signal (corresponding to the multidimensional image) to a shifted spectral signal and transforming the shifted spectral signal along a first axis. A spatial frequency component of the multidimensional image is then computed by transforming the first shifted, complex-valued image along at least one further axis perpendicular to the first axis. Thereafter, a phase-restored image is produced by converting the spatial frequency component of the multidimensional image to a shifted spatial frequency spectrum and applying an inverse transform in each second axis. Also disclosed is a system for performing the above method.

### TECHNICAL FIELD

The present invention relates, in general terms, to systems and methods for phase-restoring translational shifting of multidimensional images. In particular, the present invention can be applied in the field of Fourier-domain (FD) optical coherence tomography (OCT) to accurately restore phase components of images shifted over arbitrary real-valued displacements.

### BACKGROUND

FD-OCT is widely used in ophthalmology, velocimetry, and photothermal therapies. The phase components of the complex-valued images obtained by the FD-OCT are heavily involved in measuring the tissue or cellular dynamics such as photothermal expansion, blood flow, shear wave, and the recently discovered physiological deformation of photoreceptors in response to light stimulus. With enough signal-to-noise ratio (SNR) in the OCT image, the sensitivity of the phase components can reach tens of milliradians, capable of detecting subtle nanometer-scale movements in synthetic materials or live tissues.

While the phase components are extremely sensitive, their temporal stability is highly susceptible to the bulk motion of the sample. Such a problem is even more severe in in-vivo OCT imaging, where the tissue is constantly affected by the motion induced by heartbeat, breathing, involuntary movement of the body, and environmental vibrations, leading to de-correlated phase components during time-elapsed recordings.

One effective approach to solve the instability of phase components is to conduct image registration techniques in data post-processing, which consists of motion estimation and image correction. For motion estimation, existing technologies utilize transformation-based or feature-based methods to estimate the translational shift of multidimensional images in FD-OCT obtained from repeated cross-sectional imaging mode (termed “repeated B-scan”) or repeated volumetric imaging mode (termed “repeated C-scan”). Among these methods, some offer their estimation in the integer multiples of a pixel, while others, such as normalized cross-correlation (NCC) or phase-only correlation (POC) based methods, can offer subpixel real-valued estimation of the bulk motion. However, for the correction of multidimensional images in FD-OCT, currently, there is no existing method that can yield physically accurate phase components in the corrected image when translationally shifting the images over arbitrary real-valued displacements.

It would be desirable to overcome or alleviate at least one of the above-described problems, by providing a system and method that can generate physically accurate phase components in a corrected image when translationally shifting the images over arbitrary real-valued displacements, or at least to provide a useful alternative to existing methods.

### SUMMARY

In view of the above difficulties, proposed herein is a method for shifting multidimensional images over arbitrary real-valued displacements in FD-OCT while restoring physically accurate phase components. Embodiments of the method are not limited by the discrete sampling in pixels. With this method, complex-valued multidimensional images in FD-OCT can be shifted given any arbitrary displacements in the lateral and axial directions. The corrected images reconstructed using this method can yield accurate amplitude and phase components as if the OCT images were taken by shifting the samples physically with the same displacements.

Originating from a general FD-OCT model, a phase-restoring subpixel motion correction (PRSMC) method is proposed for post-hoc image registration in FD-OCT. This allows translational shifting of OCT images by arbitrary displacements while restoring physically meaningful phase components. With the sample movement estimated from averaged Doppler shifts or normalized cross-correlation, the OCT images are reconstructed by correcting the axial displacement in the spectrum (k) domain and the lateral displacement in the spatial frequency domain, respectively. The approaches described herein significantly reduce the motion-induced phase error, also known as decorrelation noise, when imaging moving samples, achieving phase sensitivities close to the fundamental limit set by the system's SNR.

Disclosed herein is a method for phase-restoring translational shifting of a multidimensional image, comprising:
obtaining, from an image source, a spectral signal corresponding to the multidimensional image; and
at one or more processors:
   computing a first shifted, complex-valued image by converting the spectral signal to a shifted spectral signal and transforming the shifted spectral signal along a first axis;
   computing a spatial frequency component of the multidimensional image by transforming the first shifted, complex-valued image along at least one further axis perpendicular to the first axis; and
   producing a phase-restored image by converting the spatial frequency component of the multidimensional image to a shifted spatial frequency spectrum and applying an inverse transform in each second axis.

Also disclosed is an image restoration system for phase-restoring translational shifting of a multidimensional image, comprising:
memory; and
at least one processor, the memory storing instructions that, when executed by the at least one processor, cause the at least one processor to:
   obtain, from an image source, a spectral signal corresponding to the multidimensional image;
   compute a first shifted, complex-valued image by converting the spectral signal to a shifted spectral signal and transforming the shifted spectral signal along a first axis;
   compute a spatial frequency component of multidimensional OCT image by transforming the first shifted, complex-valued image along at least one further axis perpendicular to the first axis; and
   produce a phase-restored image by converting the spatial frequency component of multidimensional OCT image to a shifted spatial frequency spectrum and applying an inverse transform in each second axis.

The image restoration system can be configured to perform the methods described herein.

Also disclosed is a non-transitory computer-readable storage medium having stored thereon instructions that, when executed by one or more processors of a computer system (e.g. the image restoration system mentioned above), cause the computer system to perform the method or methods described herein.

### BRIEF DESCRIPTION OF THE DRAWINGS

Embodiments of the present invention will now be described, by way of non-limiting example, with reference to the drawings in which:

FIG. 1 Flowchart of the proposed method for phase-restoring translational shifting of cross-sectional 2D images in FD-OCT;

FIG. 2 is a schematic diagram of the proposed PRSMC method.

FIG. 3 Flowchart of the proposed method for phase-restoring translational shifting of volumetric 3D images in FD-OCT;

FIG. 4 is a schematic diagram showing components of an exemplary computer system for performing the methods described herein;

FIG. 5 illustrates a method for eliminating the negative influence of bulk motion when imaging movement or deformation in FD-OCT; and

FIG. 6 results of an in-vivo rat retina imaging experiment employing the method of FIG. 1.

### DETAILED DESCRIPTION

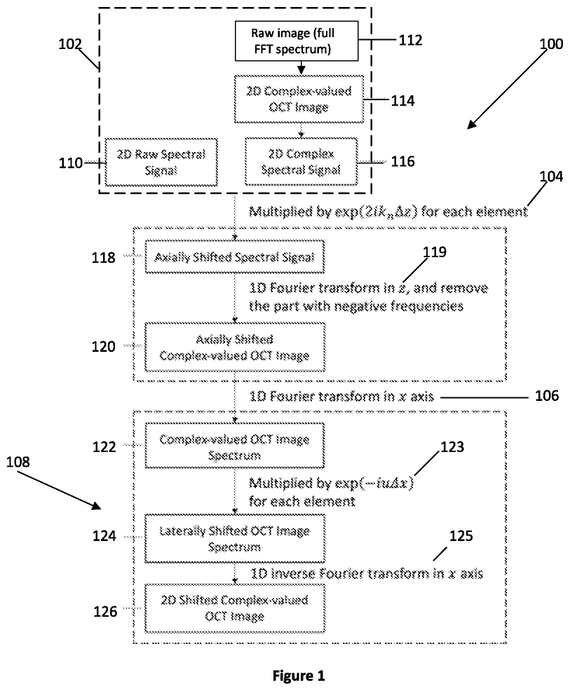

Disclosed herein are PRSMC methods for eliminating motion-induced phase error (MPE), also known as decorrelation noise, in FD-OCT. With reference to FIG. 1, a method 100 is disclosed, for phase-restoring translational shifting of a multidimensional image. While the present methods may be applied to images other than OCT, the discussion below will be given with reference to OCT images for illustration purposes.

The method 100 involves:
102: obtaining a spectral signal corresponding to the multidimensional image;
104: computing a complex-valued image that is axially shifted;
106: computing a spatial frequency component of the multidimensional image; and
108: producing a phase-restored image.

The present methods can be applied to multidimensional OCT image registration implemented at different scales. The scales generally considered for multidimensional FD-OCT are: a) individual B-scans with 2 degrees of freedom (DoFs) (x, z) for repeated cross-sectional scans, and b) individual B-scans and C-scans with 3 DoFs (x, y, z) for repeated volumetric scans. In the examples illustrated below, the axial shift is followed by lateral shift. However, the same teachings apply where lateral shift is followed by the axial shift. To that end, for illustration purposes, the z axis will be considered to extend along the axial direction and the x and y axes along the lateral directions, bearing in mind that the operations applied along the respective axes may be exchanged if the lateral shift is performed before the axial shift.

With regard to step 102, obtaining a spectral signal corresponding to the multidimensional image will generally comprise receiving the raw data collected from the imaging system—camera or detector in the OCT system. The images on the camera or detector may be single dimensional or multidimensional. Multidimensional OCT images can be obtained using raster scanning mechanisms, parallel sampling strategies or another suitable method.

In general, the raw data, OCT image or similar, is obtained from an image source, which may be a camera or other imaging system, a server (remote or local), a database or memory. Similarly, the steps of the method 100 (or method 100′) can be performed by at least one processor.

An OCT image obtained or captured by an FD-OCT system may be modelled under the assumption that the sample consists of multiple scatterers. A “scatterer” as used in the present context includes, but may not be limited to, individual components (proteins, organelles, etc.) within the sample that contribute to the back-scattered light in OCT.

The complex-valued OCT signal of each pixel is thus modelled as the weighted superposition of coherent light signals scattered from surrounding scatterers within the coherence gating—i.e. the convolution of a point spread function (PSF) with surrounding scatterers. The weights are determined by the PSF centered at that pixel. Given that we have an illumination laser of a Gaussian beam profile and a Gaussian-shaped spectrum, the PSF h(x, z) of the OCT system can be described as:

$$h ( x , z ) exp ( - 2 \frac{{x}^{2}}{{w}_{l}^{2}} ) exp ( - 2 \frac{{z}^{2}}{{w}_{z}^{2}} ) exp ( 2 {ik}_{0} z ) , \qquad ( 1 )$$

where wₗ is the 1/e² spot radius of the OCT beam focused on the sample, and w_{z} is the 1/e² width of the axial PSF. i is the imaginary unit.

Subpixel-level movements will inevitably change the weights of the scattering signal superposition, leading to an extra phase error (motion-induced phase error) if the weights remain uncorrected. Such an error is likely to be more severe for turbid samples, such as biological tissue, where the existence of speckles indicates highly complicated signal superposition within these samples.

In this model, the raw spectral interference signal obtained by the camera or detector in the OCT system is real-valued. That signal is the linear superposition of individual spectra formed between the back-scattered light from each scatterer and the reference beam. Given that each scatterer has reflectivity Rⱼ at corresponding axial coordinate zⱼ along a single line in the depth direction (termed the “A-line”), where j is the index of scatterers. The signal can be modelled by the Equation (2):

$$I ( {k}_{n} ) ∝ S ( {k}_{n} ) {\sum }_{j} {R}_{j} cos ( i 2 {k}_{n} {z}_{j} ) \qquad ( 2 )$$

where S(kₙ) is the power spectrum of the light source, and kₙ denotes N discrete spectral components due to the discrete sampling of the detector in spectrum-domain OCT (SD-OCT) or the discrete spectral lines in swept-source OCT (SS-OCT).

The corresponding depth-resolved complex-valued OCT signal Ã(z) is the discrete Fourier transform (DFT) of Equation (2), i.e., Ã(z)=DFT {I(kₙ)}.

To eliminate the motion-induced phase error, for high-speed phase-sensitive OCT imaging with repeated cross-sectional B-scans or repeated volumetric C-scans, image registration must be conducted in 2 or 3 DoFs in both the axial and the lateral directions. Depending on the dimension of the OCT image, the cross-sectional OCT image Ã(x,z) or volumetric OCT image Ã(x, y, z) can be translationally shifted in either two dimensions (2D) or three dimensions (3D) using method 100 or method 100′. In these images, x and y denote coordinates along lateral fast-scan and low-scan directions, and z continues to represent the depth dimension. This axis nomenclature will be adopted throughout, without loss of generality of the present method 100. Notably, translational motion is a much greater source of motion artifact in high-speed OCT imaging, when compared with rotational motion. Method 100 therefore focusses on translational shift between a reference image and target images—i.e. the reference image and the target images being registered to the reference image frame.

Assuming that the measured sample was shifted by −Δx and −Δz in the lateral (x) and the axial (z) directions due to bulk motion, the complex-valued OCT signals [symbol] and [symbol] of the reference and target images, respectively, should satisfy Equation (3):

$$( x , z ) = ( x + Δ x , z + Δ z ) \cdot exp ( - i 2 {k}_{0} Δ z ) , \qquad ( 3 )$$

where exp(−i2k₀Δz) represents the phase change induced by the change of optical path length (OPL), k₀ denotes the central wavenumber of the light source of the OCT system.

The axial displacement can thus be accurately corrected in the k domain under Equation (4):

$$\begin{matrix}( x + Δ x , {k}_{n} ) = ( x , {k}_{n} ) ∘ exp ( i 2 {k}_{n} Δ z ) \\ = ( x , {k}_{n} ) \cdot exp ( i 2 {k}_{0} Δ z ) ∘ exp [ 2 i ( {k}_{n} - {k}_{0} ) Δ z ] ,\end{matrix} \qquad ( 4 )$$

where [symbol] and [symbol] are the complex-valued spectral signals of the reference frame and target frame, ∘ denotes Hadamard product.

The first pixel-wise exponential term exp(i2k₀Δz) compensates the Doppler shift due to the change of OPL. The second pixel-wise exponential term exp[2i(kₙ−k₀)Δz] corrects the extra error introduced by the axial bulk motion. Axial motion can be corrected by multiplying either both exponential terms, if it is desirable to view the OCT image as though it was physically shifted back (per Equation (5)), or only the second term, if the Doppler shift is to be explored while eliminating the extra motion-induced phase error (per Equation (6)):

$$( x , {k}_{n} ) = ( x , {k}_{n} ) \cdot exp ( i 2 {k}_{0} Δ z ) ∘ exp [ i 2 ( {k}_{n} - {k}_{0} ) Δ z ] , \qquad ( 5 )$$

where [symbol] is the accurately reconstructed complex-valued spectral signal after the axial correction.

$${′}^{} ( x , {k}_{n} ) = ( x , {k}_{n} ) ∘ exp [ i 2 ( {k}_{n} - {k}_{0} ) Δ z ] , \qquad ( 6 )$$

where [symbol] is the corrected complex-valued spectral signal that retains the Doppler shift.

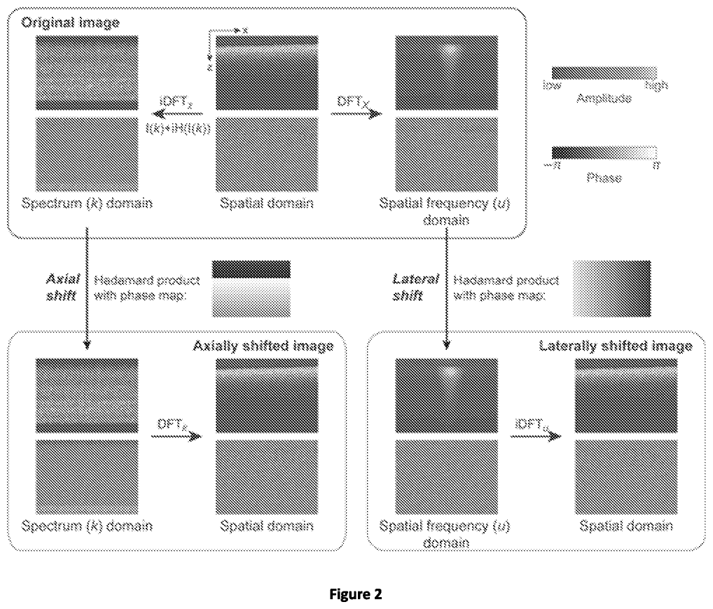

Considering the multidimensional image (e.g. target image) used in step 102 of method 100 being a cross-sectional 2D OCT image Ã(x, z): if the image needs to be shifted by a displacement of (Δx, Δz) which are not integer multiples of the pixel size, it will undergo image shifting in the axial and the lateral directions sequentially, as depicted in FIG. 2. In such cases, axial shifting is conducted on the spectral signal, by converting the spectral signal to a shifted spectral signal and transforming the shifted spectral signal along a z axis. For the translational shift, the spectral signal that is used may comprise the 2D raw spectral signal (110).

While the input may be a raw spectral signal (110), the input received at step 102 may instead be a cropped complex-valued OCT image (112). In this case, the cropped complex-valued OCT image (112) is first zero-padded to full range (114) and then converted to the complex-valued spectral signal (116).

In one example, assuming that the raw spectral signal I(x, kₙ) (110) of a particular size (x*k)—e.g. 1000*2048 pixels—the complex-valued OCT image is reconstructed by performing a Fourier transform along the k direction, which corresponds to a size of 1000*2048 pixels (x*z). However, since the negative frequency components (for z from 1 to 1024 pixels) and positive frequency components (for z from 1025 to 2048 pixels) are simply complex conjugates of each other, the negative frequency components are typically removed, to retain only the positive frequency components (for z from 1025 to 2048 pixels). This results in a cropped 2D complex-valued OCT image (112) with a size of 1000*1024 pixels (x*z).

To obtain the 2D complex-valued spectral signal I(x, kₙ) (116) from the received cropped 2D complex-valued OCT image (112), the cropped 2D complex-valued OCT image (112) is first zero-padded (arrow extending from 112 to 114) to full range-presently 1000*2048 pixels (x*z)—thereby producing a full range 2D complex-valued OCT image (114). iDFT is then performed (arrow extending from 114 to 116), along the axial direction, to produce the 2D complex-valued spectral signal (116). In other embodiments, the 2D complex spectral signal is produced by conducting a Hilbert transform H so that Ĩ(kₙ)=I(kₙ)+iH(I(kₙ)), where I(kₙ) is the recorded real-valued spectral signal on the camera or detector in the OCT system.

In some embodiments, for repeated cross-sectional B-scans a single-step DFT approach may be employed to estimate the subpixel-level displacements between repeated B-scans. An up-sampled NCC function (e.g. a 2-fold up-sampled NCC function) can be first obtained by zero-padding in the Fourier domain, and the location of its peak is used as the initial estimation of the displacements. Since only a small neighbourhood around the NCC peak is of interest, a matrix-multiplication DFT method was used to compute the x-fold up-sampled NCC map in a 1.5×1.5 pixel neighbourhood centred on the initial estimation. Compared with conventional fast Fourier transform (FFT) up-sampling strategy, the matrix multiplication approach greatly reduces the computational load.

In step 104, the raw real-valued spectral interference signal I(kₙ) (110) or the complex-valued spectral signal Ĩ(kₙ) (116) will be multiplied by an exponential term to produce the axially shifted spectral signal (118). Multiplication by the exponential term may be performed pixel-wise (i.e. pixel by pixel) on the raw real-valued spectral interference signal I(kₙ) (110) or the complex-valued spectral signal Ĩ(kₙ) (116). The exponent used in step 104 is exp(2ikₙΔz), where kₙ is a discrete spectral component. The axially shifted spectral signal (118) then undergoes a 1D Fourier transform (119) with respect to the z direction (in k domain) to produce the axially shifted complex-valued OCT image Ã(x, z−Δz) (120). It can be desirable to remove the negative frequency components after performing a 1D Fourier transform (119) since they don't provide additional information.

Under step 106, a spatial frequency component of the multidimensional image is then computed by transforming the first shifted, complex-valued image (120) along at least one further axis perpendicular to the z axis. Presently, this further axis is the x axis. The x axis is the lateral dimension in the 2D raw spectral signal or 2D complex-valued OCT image applications of method 100.

Transforming per step 106 comprises conducting a 1D Fourier transform of the axially shifted complex-valued OCT image (120) in the x direction. This results in the complex-valued spatial frequency spectrum of OCT images \tilde{F}(u, z) (122) with respect to its spatial frequencies u in the x direction.

Per step 108, the phase-restored image (126) is produced by converting the spatial frequency component of the OCT image (122) to a (laterally) shifted spatial frequency spectrum (124) and applying an inverse Fourier transform in the x axis.

In the lateral direction, given that the Nyquist sampling rate is satisfied, the lateral subpixel motion was corrected in the spatial frequency domain, which can be written as:

$$ℱ \{ ( x , z ) \} = ℱ \{ ( x , z ) \} ∘ exp ( - iu Δ x ) , \qquad ( 7 )$$

where [symbol] is the reconstructed complex-valued OCT signal after lateral correction. u is the lateral spatial frequency signal corresponding to the x axis.

In some embodiments, to convert the spatial frequency component of the OCT image (122) to a laterally shifted spatial frequency spectrum (124), each element of the complex-valued spatial frequency spectrum (122) is multiplied point-wise by an exponent. The exponent may be exp(−iuΔx) (123)—the exponent is thus based on a spatial frequency of the multidimensional image along the x axis and a shift of the multidimensional image along the x axis. Thereafter, a 1D inverse Fourier transform (125) can be conducted on the laterally shifted spatial frequency spectrum (124) over the x axis, to obtain the 2D shifted complex-valued OCT image Ã(x−Δx, z−Δz) (126).

The procedures exhibited by method 100 are illustrated in FIG. 2 for PRSMC. To correct the axial displacement per 112, 114 and 116, the complex-valued spectral signal I(kₙ) can be obtained by numerical Hilbert transform: I(kₙ)=I(kₙ)+iH(I(kₙ)), where I(kₙ) is the recorded real-valued spectral signal on the detector. A phase map determined by Equation (3) will be applied (per step 104) to shift the phase component of the spectral signal. The axially shifted images (120) will then be reconstructed by conducting discrete Fourier transform (DFT—119 of FIG. 1) of the shifted spectral signal (118) along the k direction and removing the negative frequency part. In comparison, to correct the lateral displacement, the OCT image will at first be transformed into the spatial frequency (u) domain by performing DFT along x direction (106). The spatial frequency signal will then be multiplied with the phase map determined by Equation (4)—123 in FIG. 1. Eventually, the laterally shifted OCT image can be reconstructed (126) by transforming the spatial frequency signal (124) back to the spatial domain with inverse discrete Fourier transform (iDFT) along the u direction (125).

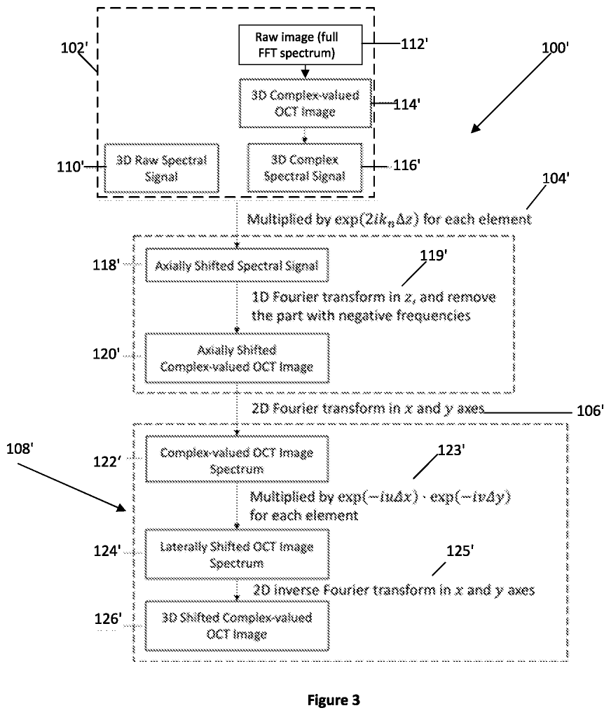

Using these methods, the PRSMC can lock in the SNR of the OCT signals at the optimal value. This can avoid any intensity fluctuation caused by the motion. Without motion correction, the sample motion often distorts the time-elapsed repeated recording at the same location (M-scan) and results in the SNR variation when the probing pixel is fixed. In contrast, after image correction using the PRSMC method, stable M-scans and constant SNR values can be obtained over a multi-second recording. Such a feature is particularly useful for tracking the motion of a single layer or a reflective surface in phase-sensitive OCT, as it ensures that the optimal phase sensitivity can be reached throughout the time course.

Where FIG. 1 refers to application of the method 100 to 2D raw spectral signals or 2D complex-valued OCT images. In contrast, FIG. 3 illustrates embodiments where the method 100′ is applied to a multidimensional image being a 3D raw spectral signal or 3D complex-valued OCT image. The signal or image is therefore a volumetric image Ã(x, y, z) to be translationally shifted with a displacement of (Δx, Δy, Δz). The steps of method 100′ can largely be achieved using the same approach as the corresponding steps of method 100. For this reason, unless stated here the skilled person will appreciate how to employ the discussion of method 100 in performance of method 100′ and the steps of method 100′ have correspondingly been given the same reference numerals as the steps of method 100, with the addition of an apostrophe to distinguish between discussion of the two figures.

For repeated volumetric C-scans, the translational motion of individual B-scans in the target volume respect to the reference volume can be estimated following the coarse-to-fine strategy. The single-step DFT approach can then be employed to extend the previous pixel-level estimation to subpixel-level in the depth (z) and the fast scan (x) dimensions. In the coarse estimation step, a set of target sub-volumes consisting of several consecutive B-scans may be selected from the target volume. The positions of those target sub-volumes in the reference volume can then be estimated with 3D NCC method. The coarse shift for each B-scan can then be computed by linearly interpolating the obtained sparse coarse shifts in the y direction. In the fine estimation step, for each target B-scan, a reference sub-volume may be defined according to the coarse shift. The single-step DFT method can be used to calculate the correlation between each target B-scan and individual B-scans in its corresponding reference sub-volume. Finally, the location corresponding to the maximum correlation value may be found as the estimated displacement (−Δx,−Δy,−Δz) for each target B-scan.

The axial shifting operation of method 100′ can still be achieved using the same approach as the above steps for the cross-sectional OCT images (i.e. 2D raw spectral signal or 2D complex-valued OCT image), starting from the 3D raw spectral signal (110′) or 3D complex-valued spectral signal and performing all steps up to generating the axially shifted complex-valued OCT image (120′). In the case of a 3D complex-valued spectral signal, this is produced by receiving a cropped 3D complex-valued OCT image (112′), zero-padding the 3D complex-valued OCT image to full range (114′) and performing iDFT on the full range 3D complex-valued OCT image (114′) to produce the 3D complex-valued spectral signal (116′).

For the lateral shifting operation (106′), the differences are that the previous 1D Fourier transform (106) and 1D inverse Fourier transform in the x direction (125) need to be changed to 2D Fourier transform (106′) and 2D inverse Fourier transform (125′) in both the x and y directions. Also, each element of the complex-valued OCT image spectrum \tilde{F}(u, v, z) (122′) will be multiplied by exp(−iuΔx)·exp(−ivΔy) (123′), where u and v denote the spatial frequencies along the x and y axes, respectively.

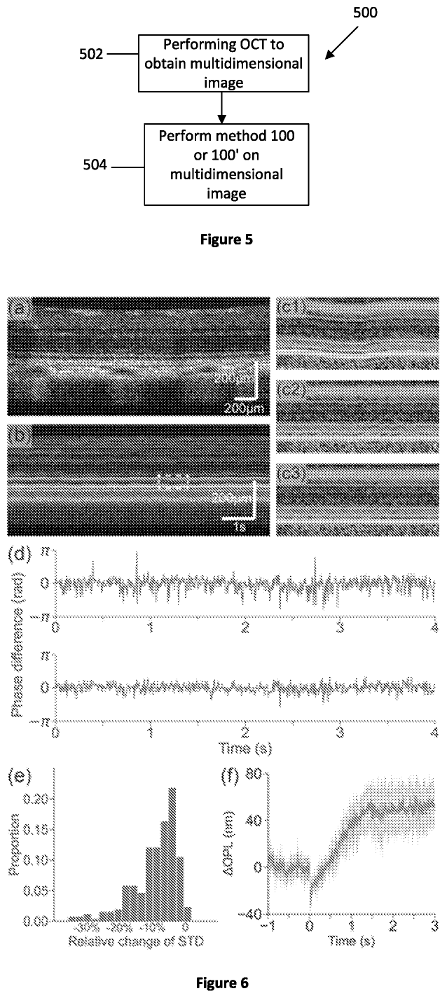

The method 100 can further be used in a method 500, as shown in FIG. 5, for imaging movement or deformation in FD-OCT. Such a method 500 includes performing OCT to obtain a multidimensional image (502) and thereafter performing the method 100 or 100′ on the multidimensional image to eliminate the negative influence of bulk motion on measurement accuracy and sensitivity (504), for imaging movement or deformation.

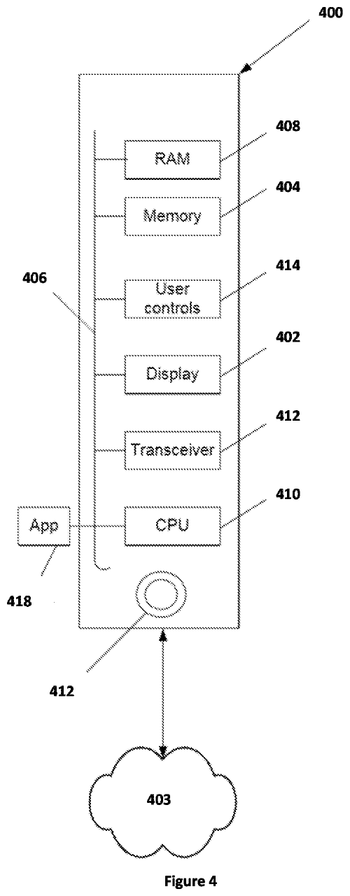

FIG. 4 is a block diagram showing an exemplary computer device 400, in which the methods 100 and 100′ may be practiced. The computer device 400 may be a mobile computer device such as an imaging device, a smart phone, a wearable device, a palm-top computer, an on-board computing system or any other computing system, or other device.

As shown, the mobile computer device 400 includes the following components in electronic communication via a bus 406:
(a) a display 402;
(b) non-volatile (non-transitory) memory 404;
(c) random access memory (“RAM”) 408;
(d) N processing components 410;
(e) a transceiver component 412 that includes N transceivers; and
(f) user controls 414.

Although the components depicted in FIG. 4 represent physical components, FIG. 4 is not intended to be a hardware diagram. Thus, many of the components depicted in FIG. 4 may be realized by common constructs or distributed among additional physical components. Moreover, it is certainly contemplated that other existing and yet-to-be developed physical components and architectures may be utilized to implement the functional components described with reference to FIG. 4.

The display 402 generally operates to provide a presentation of content to a user, and may be realized by any of a variety of displays (e.g., CRT, LCD, HDMI, micro-projector and OLED displays). The display 402 may, for example, render or display the phase-restored translationally shifted multidimensional OCT images to a physician or other user.

In general, the non-volatile data storage 404 (also referred to as non-volatile memory) functions to store (e.g., persistently store) data and executable code. The system architecture may be implemented in memory 404, or by instructions stored in memory 404.

In some embodiments for example, the non-volatile memory 404 includes bootloader code, modem software, operating system code, file system code, and code to facilitate the implementation components, well known to those of ordinary skill in the art, which are not depicted nor described for simplicity.

In many implementations, the non-volatile memory 404 is realized by flash memory (e.g., NAND or ONENAND memory), but it is certainly contemplated that other memory types may be utilized as well. Although it may be possible to execute the code from the non-volatile memory 404, the executable code in the non-volatile memory 404 is typically loaded into RAM 408 and executed by one or more of the N processing components 410—i.e. the one or more processors (N processing components 410) may then perform the method 100 or method 100′. The non-volatile data storage 404 or the RAM 408 may thus comprise instructions that, when executed by one or more processors (i.e. the N processing components 410), cause the one or more processors 410, and thus the system 400, to perform the method 100 or 100′.

One or both of non-volatile memory 404 and RAM 408 may also temporarily store raw images, OCT images and other information on which the method 100 or method 100′ operates.

The N processing components 410 in connection with RAM 408 generally operate to execute the instructions stored in non-volatile memory 404. As one of ordinarily skill in the art will appreciate, the N processing components 410 may include a video processor, modem processor, DSP, graphics processing unit (GPU), and other processing components.

The transceiver component 412 includes N transceiver chains, which may be used for communicating with external devices via wireless networks (403). Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks. The transceiver components 412 may connect to a database in which the raw spectral signal, or FD-OCT image (complex-valued OCT image) is stored, or may connect directly to the camera or detector.

The system 400 of FIG. 4 may be connected to any appliance 418, such as a camera or detector for FD-OCT imaging, or an external database from which raw spectral signals or complex-valued OCT images can be acquired.

It should be recognized that FIG. 4 is merely exemplary and in one or more exemplary embodiments, the functions described herein may be implemented in hardware, software, firmware, or any combination thereof. If implemented in software, the functions may be stored on or transmitted over as one or more instructions or code encoded on a non-transitory computer-readable medium 404. Non-transitory computer-readable medium 404 includes both computer storage medium and communication medium including any medium that facilitates transfer of a computer program from one place to another. A storage medium may be any available medium that can be accessed by a computer.

In some embodiments, the system 400 may be a custom-built spectral-domain point-scan OCT system, employed for both phantom and rodent optoretinogram (ORG) experiments. The appliances 418 may comprise a superluminescent diode, detector, galvo scanner, objective lens, ocular lens and others. The superluminescent diode (e.g. cBLMD-T-850-HP-I, Superlum, Ireland) may have a central wavelength of 850 nm and a FWHM bandwidth of 165 nm, providing a theoretical axial resolution of 1.9 μm in air. The detector (e.g. transceiver 412 or device connected thereto or a connected camera or detector appliance 418) of this OCT system is a spectrometer equipped with a line-scan camera (OctoPlus, Teledyne e2v, UK) with a maximum acquisition rate of 250,000 lines per second for 2048 pixels, which allows an imaging depth of 1.07 mm in air. The sample arm can be modified according to specific imaging requirements.

For phantom experiments, an objective lens was placed after the galvo scanner to focus the beam on the sample and achieve a lateral resolution of 3.3 μm in air. For rodent ORG experiment, a scan lens (80 mm doublet) and an ocular lens (30 mm and 25 mm doublet) were used to conjugate the galvo scanner to the pupil plane. Their focal lengths were chosen to achieve smaller beam size and enlarged field of view. The theoretical lateral resolution was estimated to be 7.2 μm based on a standard rat eye model.

Method 100 and method 100′ can be applied to eliminate image distortion resulting from bulk tissue motion while maintaining high phase stability and phase sensitivity in sub-pixel image registration. The present methods 100, 100′ have been validated in in-vivo retinal imaging experiments on wild-type rats. In experiments, 800 repeated B-scans with 1000 A-lines per B-scan were recorded using a custom point-scan phase-resolved OCT system, with a total acquisition time of 4 seconds. FIG. 6(a) shows the structural image of the rat retina obtained by the present OCT system 400, and FIG. 6(b) shows a time-elapsed M-scan consisting of repeated A-lines at the same location on the retina. As shown in the enlarged view of the M-scan, the distortion due to the tissue motion was clearly eliminated using method 100 (FIG. 6(c3)), compared with the motion artefacts seen in the original uncorrected image (FIG. 6(c1)) and the serrated residual image distortion left from the conventional pixel-level correction method (FIG. 6(c2)).

The phase difference between the brightest pixel of the inner segment/outer segment junction (IS/OS) and the rod outer segment (ROS) on one A-line was calculated to evaluate the phase stability. As shown in FIG. 6(d), in pre-stimulus period, compared with the result using conventional pixel-level correction method (FIG. 6(d) top), the phase noise was significantly suppressed using our proposed method (FIG. 6(d) bottom). Statistically, compared with the pixel-level correction method, the standard deviation (STD) of the phase noise were improved by 8.6±6.0% using method 100, as is illustrated by FIG. 6(e). As shown in FIG. 6(f), after sub-pixel image registration using employing the present phase-restoring image shifting method 100, the optoretinogram (ORG) signal of the rat retina was clearly observed, including both early contraction and late elongation of the photoreceptors in response to light stimulus.

The present methods will promote non-invasive imaging of nanometer-scale movement or cellular deformation in clinical applications on all sorts of FD-OCT systems, including point-scan, line-scan, and full-field systems. While OCT has been widely used for structural imaging in ophthalmology, the present methods improve the accuracy of imaging cellular dynamics with applications functional diagnosis, particularly for emerging optoretinogram technologies that measure the physiological response of the retina non-invasively and all-optically. The present methods allow accurate correction of the phase components disturbed by the inevitable bulk motions in live tissue without additional hardware, and can be easily applied to every clinical OCT system that utilizes phase components for imaging.

It will be appreciated that many further modifications and permutations of various aspects of the described embodiments are possible. Accordingly, the described aspects are intended to embrace all such alterations, modifications, and variations that fall within the spirit and scope of the appended claims. For example, mathematical equivalents, substitutions of one mathematical transformation for another, or reordering a transformation and its inverse transformation, are all considered to fall within the scope of the present disclosure. Multiplying the inverse Fourier transform of the image by an exponential term and subsequently performing Fourier transform can be substituted with multiplying the Fourier transform result of the image by a reordered exponential term that is equivalent mathematically and subsequently performing inverse Fourier transform.

As used herein, “and/or” refers to and encompasses any and all possible combinations of one or more of the associated listed items, as well as the lack of combinations when interpreted in the alternative (or).

As used in this application, the singular form “a,” “an,” and “the” include plural references unless the context clearly dictates otherwise. For example, the term “an agent” includes a plurality of agents, including mixtures thereof.

Throughout this specification and the statements which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Throughout this specification and the statements which follow, unless the context requires otherwise, the phrase “consisting essentially of”, and variations such as “consists essentially of” will be understood to indicate that the recited element(s) is/are essential i.e. necessary elements of the invention. The phrase allows for the presence of other non-recited elements which do not materially affect the characteristics of the invention but excludes additional unspecified elements which would affect the basic and novel characteristics of the method defined.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A method for phase-restoring translational shifting of a multidimensional optical coherence tomography (OCT) image, comprising:
obtaining, from an image source, a spectral signal corresponding to the multidimensional OCT image; and
at one or more processors:
computing a first shifted, complex-valued image by converting the spectral signal to a shifted spectral signal and transforming the shifted spectral signal along a first axis;
computing a spatial frequency component of the multidimensional OCT image by transforming the first shifted, complex-valued image along at least one further axis perpendicular to the first axis; and
producing a phase-restored image by converting the spatial frequency component of the multidimensional OCT image to a shifted spatial frequency spectrum and applying an inverse transform in each of the at least one further axis.

2. The method of claim 1, wherein the multidimensional OCT image is a cropped complex-valued OCT image and obtaining the spectral signal comprises zero-padding the cropped complex-valued OCT image to produce a full range complex-valued OCT image, and transforming the full range complex-valued OCT image to generate the spectral signal, the spectral signal being a complex-valued spectral signal.

3. The method of claim 2, wherein transforming the full range complex-valued OCT image to generate the complex-valued spectral signal comprises applying an inverse Fourier transform to the full range complex-valued OCT image along the axial direction.

4. The method of claim 1, wherein the multidimensional OCT image is a multidimensional complex-valued OCT image and obtaining the spectral signal comprises receiving, from the image source, a real-valued spectral signal and, at the one or more processors, conducting a Hilbert transform on the real-valued spectral signal.

5. The method of claim 1, wherein converting the spectral signal to a shifted spectral signal comprises performing pixel-wise multiplication of the spectral signal by an exponential term.

6. The method of claim 5, wherein the first axis is the z axis, and the exponential term is based on a discrete spectral component and a shift of the multidimensional OCT image along the z axis.

7. The method of claim 6, wherein the exponential term is expressed as:
exp(2ikₙΔz)
where kₙ is the discrete spectral component, Δz is a shift of the multidimensional OCT image along the z axis and i is an imaginary unit.

8. The method of claim 1, wherein converting the spatial frequency component of the multidimensional OCT image to a shifted spatial frequency spectrum comprises performing point-wise multiplication of the spatial frequency component of the multidimensional OCT image by an exponential term.

9. The method of claim 8, wherein the exponential term is based on a spatial frequency of the multidimensional OCT image along each further axis and a shift of the multidimensional OCT image along each further axis.

10. The method of claim 9, wherein the multidimensional OCT image is a 2-dimensional image and the exponential term is expressed as:
exp(−iuΔx)
where Δx is a shift of the multidimensional OCT image along a said further axis, being an x axis, u is the spatial frequency of the multidimensional OCT image along the said further axis and i is an imaginary unit.

11. The method of claim 9, wherein the multidimensional OCT image is a 3-dimensional image and the exponential term is expressed as:
$$exp ( - iu Δ x ) \cdot exp ( - iv Δ y )$$
where Δx and Δy are shifts of the multidimensional OCT image along an x axis and a y axis, respectively, the y axis being perpendicular to the x axis, u and v are the spatial frequencies of the multidimensional OCT image along the x axis and y axis, respectively, and i is an imaginary unit.

12. The method of claim 1, wherein transforming the shifted spectral signal with respect to the first axis comprises applying a 1-dimensional Fourier Transform in a k direction to obtain the first shifted, complex-valued image while removing components of the first shifted, complex-valued OCT image having a negative frequency.

13. The method of claim 1, wherein the multidimensional OCT image is a 2-dimensional image and:
transforming the first shifted, complex valued image along at least one further axis comprises applying a 1-dimensional Fourier Transform in one said further axis; and
applying an inverse transform in each further axis comprises applying a 1-dimensional inverse Fourier Transform in the one further axis.

14. The method of claim 1, wherein the multidimensional OCT image is a 3-dimensional image and:
transforming the first shifted, complex valued image along at least one further axis comprises applying a 2-dimensional Fourier Transform in an x axis and a y axis; and
applying an inverse transform in each further axis comprises applying a 2-dimensional inverse Fourier Transform in the x axis and y axis.

15. A method for imaging movement or deformation in Fourier-domain optical coherence tomography (OCT) comprising:
performing OCT to obtain a multidimensional OCT image; and
performing the method of claim 1 on the multidimensional OCT image.

16. An image restoration system for phase-restoring translational shifting of a multidimensional optical coherence tomography (OCT) image, comprising:
memory; and
at least one processor, the memory storing instructions that, when executed by the at least one processor, cause the at least one processor to:
obtain, from an image source, a spectral signal corresponding to the multidimensional OCT image;
compute a first shifted, complex-valued image by converting the spectral signal to a shifted spectral signal and transforming the shifted spectral signal along a first axis;
compute a spatial frequency component of the multidimensional OCT image by transforming the first shifted, complex-valued image along at least one further axis perpendicular to the first axis; and
produce a phase-restored image by converting the spatial frequency component of the multidimensional OCT image to a shifted spatial frequency spectrum and applying an inverse transform in each of the at least one further axis.

17. The image restoration system of claim 16, wherein the multidimensional OCT image is a cropped complex-valued OCT image and said obtain the spectral signal comprises zero-padding the cropped complex-valued OCT image to produce a full range complex-valued OCT image, and transforming the full range complex-valued OCT image to generate the spectral signal, the spectral signal being a complex-valued spectral signal.

18. A non-transitory computer-readable storage medium having stored thereon instructions that, when executed by one or more processors of a computer system, cause the computer system to perform the method of claim 1.
